(19) United States
(12) Patent Application Publication
(10) Pub. No.: US 2005/0111154 A1
(43) Pub. Date: May 26, 2005

(54) Power connector

(76) Inventor: David John Baughan, Kilsyth (AU)

Correspondence Address: BIRCH STEWART KOLASCH & BIRCH, PO BOX 747, FALLS CHURCH, VA, 22040-0747, US

(21) Appl. No.: 10/718,802

(22) Filed: Nov. 24, 2003

(51) Int. Cl. H02H 3/08

(52) U.S. Cl. 361/93.1

(57) ABSTRACT

Electrical power connector (2) having a power inlet (4), a first power outlet (8) coupled to said power inlet, at least one second power outlet (10) which is coupled to said power inlet by switch means (28, 30), and switch control means (34, 36, 40, 42, 44) for controlling the state of the switch means in accordance with the average current supplied to the first power outlet (8). The casing (6) of the connector is formed from two parts (6A, 6B) which releasably hold the power outlets (8), (10).

This invention relates to a power connector such as a multiple power outlet board for domestic or commercial use.

Frequently electrical apparatus for use in a domestic or commercial application can comprise a number of individual components, each of which operates from a separate power supply. For example, a computer for use in a home or office might comprise a central processing unit (CPU) which contains the processing circuitry, disc drives and the like. Attached to the CPU, and forming part of the computer system, may be a screen or visual display unit (VDU), a printer or plotter, a CD ROM and other peripherals which are operable by or with the CPU. The VDU, printer and other peripherals commonly have separate power supplies and thus require their own source of mains electricity, in addition to the mains electricity supplied to the CPU. In many applications, the screen, printer and other peripherals are only operable in conjunction with the CPU, yet their power supplies are separately controlled by individual ON/OFF switches. The situation may be similar in many audio reproduction components systems, such as high fidelity stereo reproduction systems.

In some systems, especially computer and video games systems, when the main CPU is turned off the VDU goes blank. This often leaves the user in a false belief that the entire system is off when in fact the VDU, the printer and other peripherals are still in fact turned ON. This can lead to expensive unwarranted power consumption but, more importantly, a genuine risk of fire especially when left unattended for long periods. In some instances, it may therefore be found desirable to control the supply of mains electricity to a plurality of components merely by switching a single component ON or OFF. For example, it may be useful to switch off mains electrical power to a video monitor and printer of a computer system simply by switching off the CPU of that computer. Again, it may be useful in conjunction with a bedside lamp and an electric blanket, so as to cause the blanket to be turned off when the lamp is turned off to reduce the likelihood of electrocution or fire.

The multiple components of the types of electrical apparatus described above are generally connected to the mains electricity via multiple mains electricity wall outlets, or alternatively, via a multiple power outlet board which is in turn connected to a single mains electricity wall outlet. In some instances, the location of the mains electricity wall outlets, or the multiple power outlet board are inconveniently located and cannot be easily accessed without moving some of the surrounding components or furniture. Where multiple power outlet boards are located for accessibility there is usually the requirement for manual connection and disconnection of components, which can be dangerous to the consumer as the task is performed when the multiple outlet power board remains connected to a live mains electricity wall outlet. Furthermore, the multiple components of the types of electrical apparatus described above are generally interconnected for the passing of electrical signals therebetween, such as audio signals in the case of an audio system, or various digital and other control signals in the case of a computer system.

According to the present invention there is provided an electrical power connector, said connector including a power inlet, a first power outlet coupled to said power inlet, at least one second power outlet which is coupled to said power inlet by switch means, and switch control means for controlling the state of the switch means in accordance with the average current supplied to the first power outlet.

Preferably, the switch control means includes current sensing means for sensing AC current supplied to the first power outlet.

The connector may incorporate a circuit breaker which interrupts supply of electric power to the outlets when excess current is drawn. Preferably, means is provided for protecting equipment connected to the connector against high voltage spikes or other transients in the electric supply when applied to the connector.

Preferably further, the switch control means includes a current averaging circuit which produces output signals representative of the average AC current supplied to the first power outlet.

Preferably further, the switch control means includes a threshold circuit which compares the output signals of the current averaging circuit to a reference so as to produce a switching signal when a predetermined difference is detected at the input of the threshold circuit.

Preferably further, the switch means includes a relay coil and contacts and wherein the switch control means includes a relay driver circuit which is coupled between the output of the threshold circuit and the relay coil.

Preferably further, the current sensing means includes an adjustable gain control means which can be adjusted so that the switch means changes state at a point corresponding to a predetermined electrical load connected to the first power outlet.

In use, the predetermined load connected to the first power outlet would normally be the current drawn in the standby state of a piece of electrical equipment such as a computer CPU. The arrangement is such that when the CPU is in the standby state, the switch means is off so that all other electrical devices connected to the other power outlets are in an off state. When, however, the device coupled to the first outlet is activated to an active state, this will cause an increase in the average current supplied thereto. This increase in average current is sensed by the switch control means and thereafter the switch means can cause supply of power to the other power outlets.

By monitoring the average current supplied to the first power outlet, any short term effects such as switching transients or the like can effectively be eliminated to thereby avoid unwanted switching on or off of electrical loads coupled to the other power outlets.

The circuitry may include a delay or low pass filter to further avoid the possibility of unwanted turning on or off of the switch means caused by transient conditions in the current at the first power outlet.

The invention also provides a method of controlling the supply of power to a plurality of electrical loads, the method including the steps of monitoring the average current supplied to a first of said loads, controlling switch means coupled to the loads other than said first load in accordance with said monitored average current to thereby control supply of power to the loads other than said first load.

Preferably, the first load has an off or standby state and wherein the step of controlling the switch means is adjusted so that the switch means is off when the first load is in the off or standby state.

Generally, the off state will be a state where no current is drawn by the first load. In the standby state, some small quiescent current may be drawn by the first load, but that current is substantially less than the current drawn when the first load is in an operative state.

Preferably further, the method includes the step of monitoring the average current supplied to the first of said loads in a standby state and adjusting control means for controlling said switch means so that when there is an increase in average current from said standby state, said switch means changes state to thereby supply power to loads other than said first load.

In another aspect, the invention provides an electrical power connector having an electrical power outlet, and electrical circuitry connected to the outlet, the outlet being removably retained between two parts of a casing of the connector which are releasably connected together, whereby, on release of the connection between the parts, the outlet is released to permit replacement thereof. The parts of the casing, and the outlet, may be formed so as that, when the outlet is so retained, movement of the outlet inwardly and outwardly and rotationally with respect to the casing is prevented by engagement of peripheral protrusions or other portions of the outlet with portions of the casing. One of the casing parts may carry the electrical circuitry, and the other is arranged for mounting of the connector on a surface. The outlet may be one of two power outlets each removably retained between the casing parts. In this case, the outlets may be at opposite ends of the casing.

In another aspect the invention provides an electrical power connector having an electrical power inlet and an electrical power outlet, and electrical circuitry interconnecting these, the connector having a casing being formed from two parts releasably connected together, one said part carrying the electrical circuitry, and the other being arranged for mounting of the connector on a surface.

The invention will now be further described with reference to the accompanying drawings, in which:

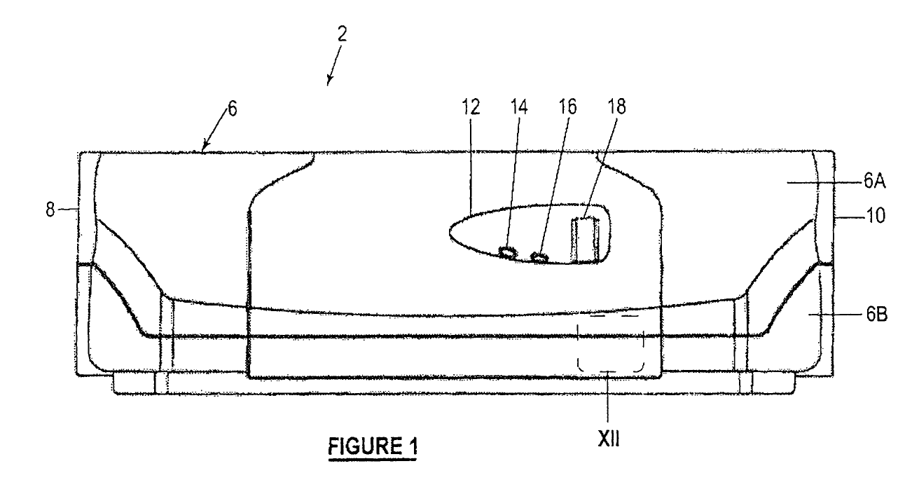

FIG. 1 is a front view of a power connector of the invention;

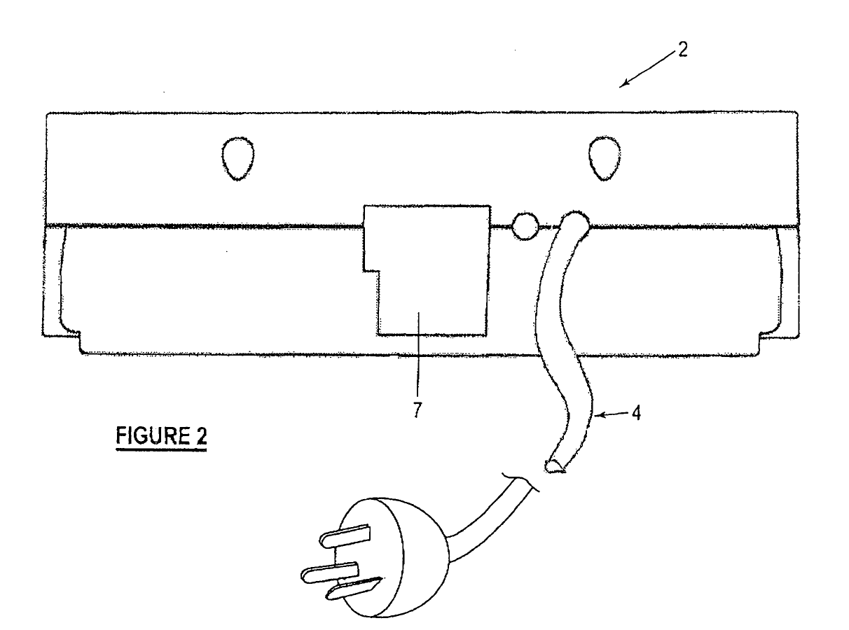

FIG. 2 is a rear view of the connector;

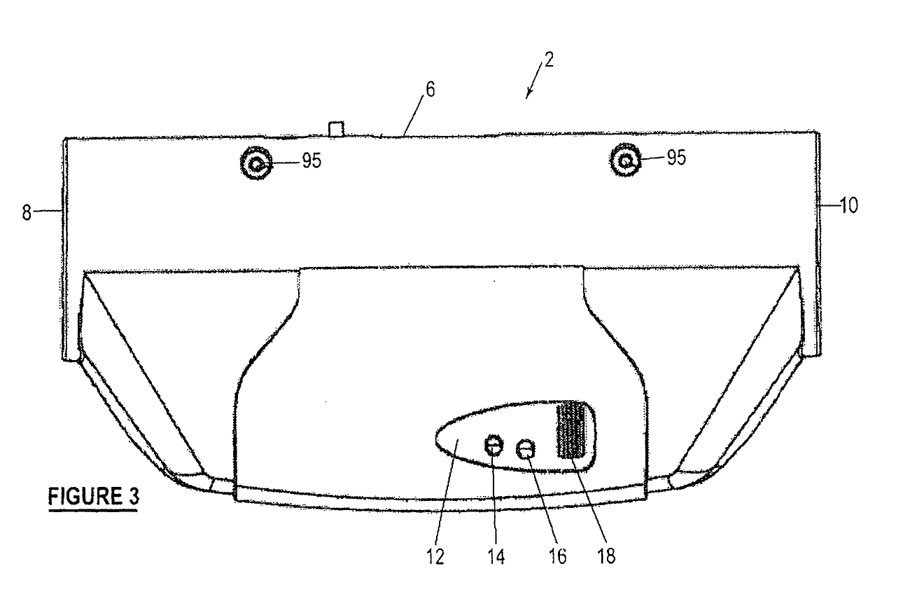

FIG. 3 is a plan view of the connector;

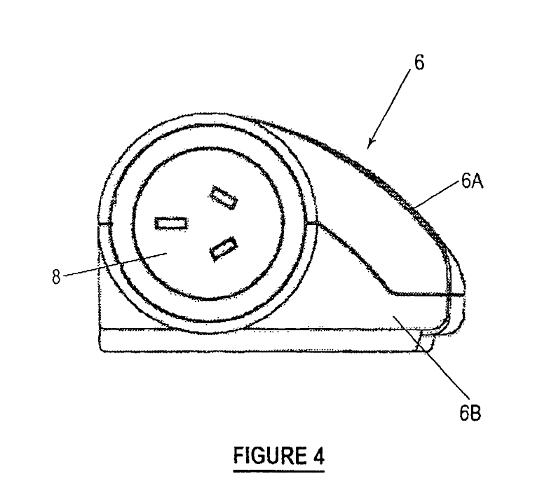

FIG. 4 is an end view of the connector;

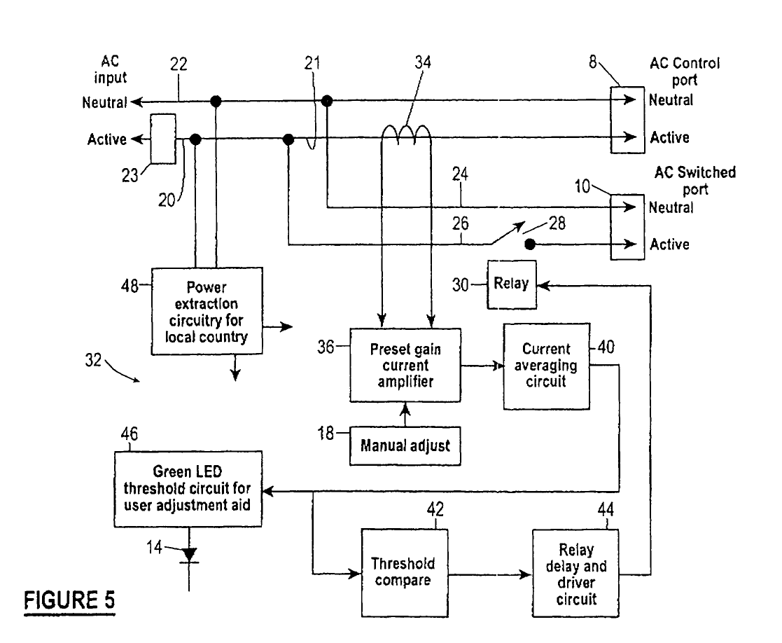

FIG. 5 is a block diagram of the circuitry of the connector;

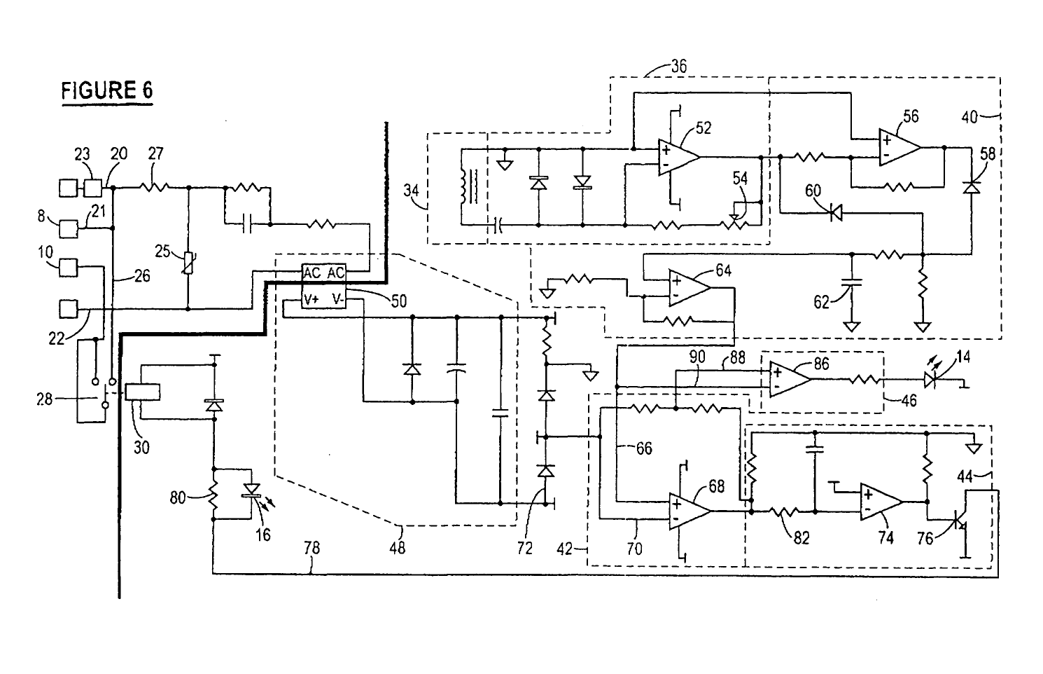

FIG. 6 is a circuit diagram for the connector;

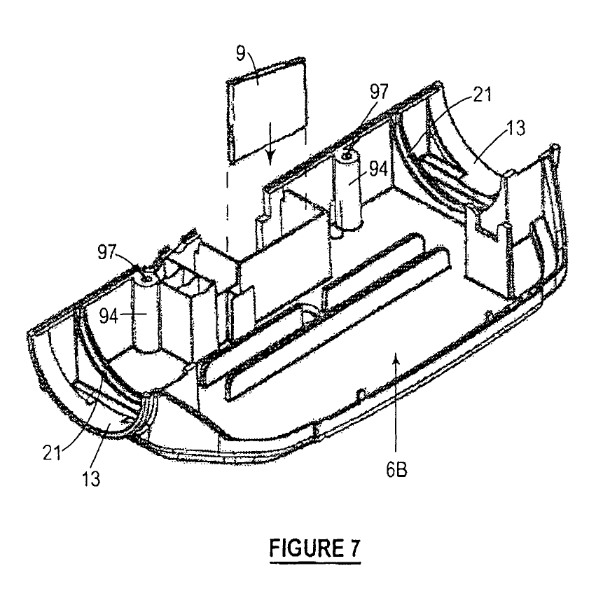

FIG. 7 is a perspective view of one part of the casing of the connector of FIG. 1;

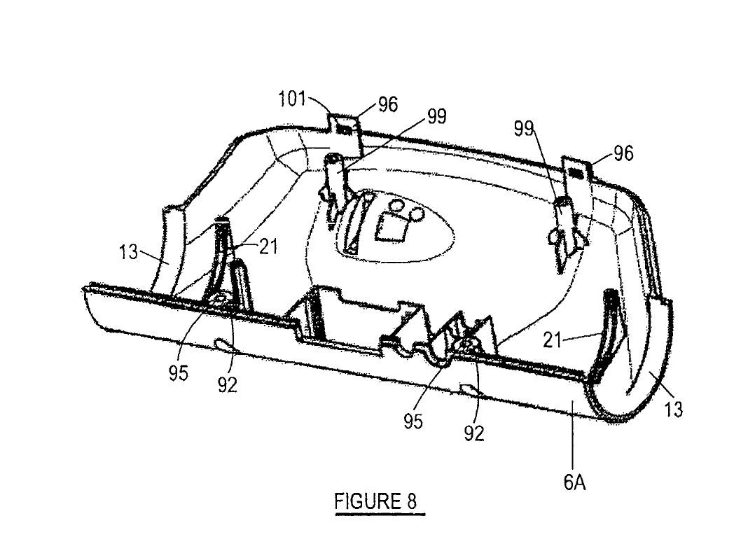

FIG. 8 is a perspective view of another part of the casing of the power connector of FIG. 1;

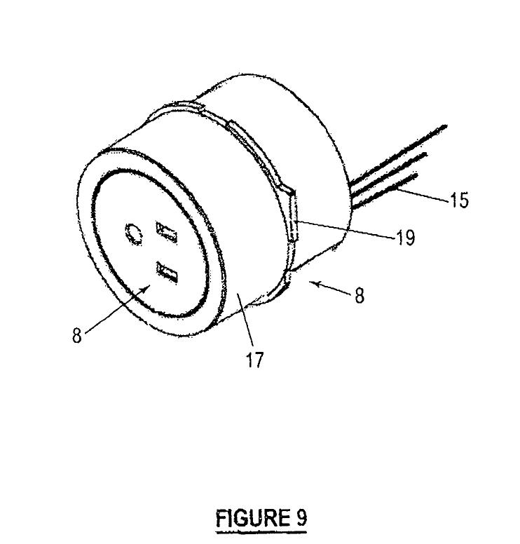

FIG. 9 is a perspective view of a socket incorporated into the connector of FIG. 1;

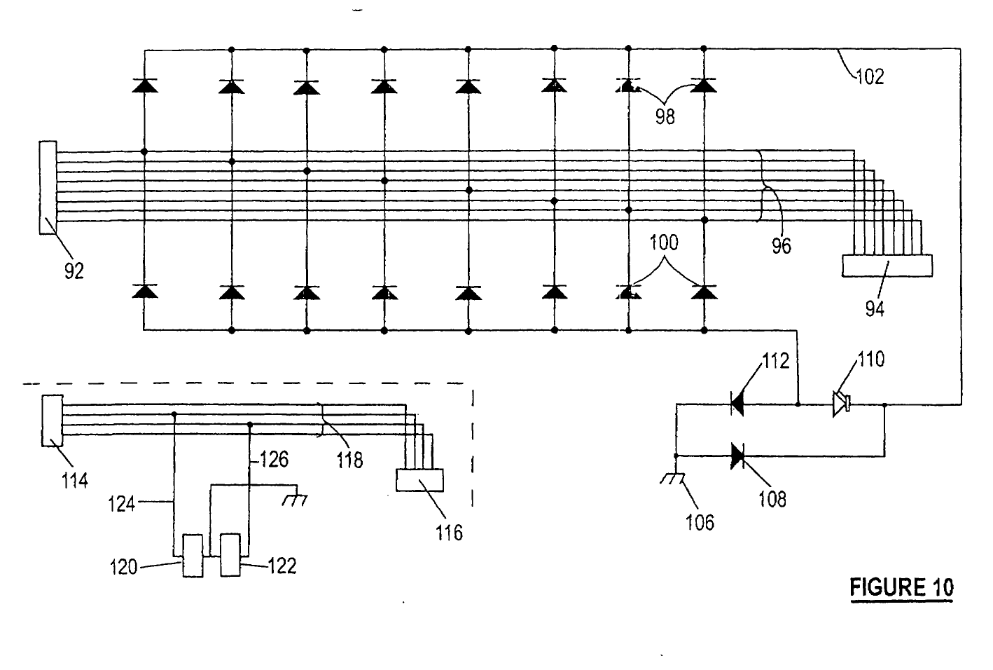

FIG. 10 is a circuit diagram of a modem and network protection module usable in the connector of FIG. 1;

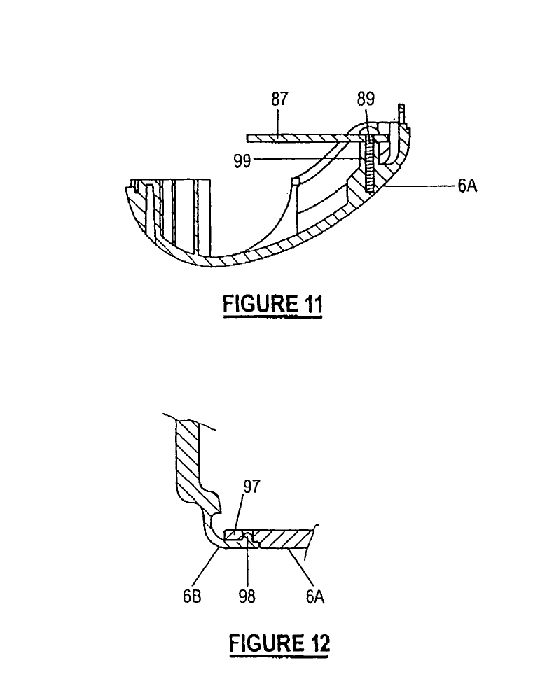

FIG. 11 is a transverse cross-section of the casing part of FIG. 8; and

FIG. 12 is a fragmentary transverse section in the region “XII” in FIG. 1.

FIGS. 1 to 4 illustrate a connector 2 constructed in accordance with the invention. This includes a power lead 4 for connecting the connector to a supply of mains power. The connector includes a casing 6 which is provided with first and second power outlet sockets 8 and 10 at either side thereof. The front of the casing includes a curved recess 12 in which are located indicating LEDs 14 and 16. The recess 12 also includes an adjusting thumb wheel 18. The rear of the casing 6 includes a snap out panel 7 that may be removed to install an optional modem and network protection module 9, described later.

As shown in FIG. 4, casing 6 is formed of two separable parts, a top part 6A and a bottom part 6B (FIGS. 8 and 7 respectively). The sockets 8, 10 are formed as units (FIG. 9) which are held in position by the two parts 6A, 6B, when these are releasably latched together to form the casing 6. However, by releasing the latching and separating the halves, the sockets can be removed and replaced by other sockets, such as sockets designed to meet the requirements of different countries.

The manner of attachment of the sockets 8, 10 within the casing 6 may be more readily ascertained from FIGS. 7 to 9. As shown, the parts 6A, 6B of the casing 6 have at opposite ends thereof portions 13 which, when the two parts are fitted together, define annular portions which fit around and clasp cylindrical bodies 17 of the outlet sockets 8 and 10. Movement of the bodies 17 in and out of the casing is prevented by fitting of an outstanding rim portion 19 on each socket into slot like openings 21 formed in the interior of each casing half. The rim portions 19 are non-circular and have abutments which interfit with corresponding abutment surfaces within each slot 21 so as to prevent rotation of the sockets 8, 10. The parts 6A, 6B may be releasably held together in any suitable way. FIG. 7 shows internal bosses 92, 94 on the respective parts 6A, 6B, which, when the parts are positioned together, are coaxially aligned at the rear of the casing 6. Bosses 92 have through bores 95 so that screws may be inserted into these from the outer side of the part 6A, to screw into bores 97 in the bosses 94, for holding the parts together at the rear of the casing. To hold the parts together at the front of the casing, the parts 6A, 6B have releasable interlocking portions 96, 98. (FIG. 12). Portions 96 are formed as apertured projections and portions 98 as internal catch elements that snap fit into the apertures in the portions 96 when the parts 6A, 6B are brought together.

To facilitate connections to the circuitry the sockets may be provided with fly-leads 15 which are connected at one end to the internal contacts of the sockets, these being arranged at the other ends to be releasably coupled into the circuitry of the connector. Of course, the plug at the end of the power lead 4 would normally be changed to conform its pin configuration to the contact arrangement of the sockets 8, 10, should these be changed.

In the illustrated embodiment, the first socket 8 functions as an AC control port or master socket. The connector of the invention includes circuitry for monitoring the average current supplied to the first socket 8 and is operable to switch AC power to the second socket 10 in accordance with monitored average current to the first socket 8, as will be described in more detail below.

FIG. 5 is a block diagram of the control circuitry located within the casing 6. The circuitry includes active and neutral lines 20 and 22 which in use would be connected to corresponding conductors in the lead 4. A branch conductor 21 connects the active terminal of the socket 8 to the line 20 via a 10 ampere circuit breaker 23, as shown. The circuit breaker is arranged to go to an open circuit condition and shut off power to the control circuitry in the event that the total power drawn exceeds 10 amperes. The neutral line 22 is directly connected to the neutral terminal in the first socket 8, as shown. The neutral terminal in the second socket 10 is directly connected to the neutral line 22 by conductor 24. The active terminal of the socket 10 is connected by means of a conductor 26 to the active line 20 via contacts 28 which are controlled by a relay coil 30 which form part of control circuitry generally designated by the reference numeral 32.

The control circuitry 32 includes a current sensing coil 34 which senses current flowing in the branch conductor 21 to the first socket 8. Current signals developed in the coil 34 are amplified by means of a current amplifier 36 coupled to the thumb wheel 18 which operates as a gain adjusting means, which will be described in more detail below. Output from the current amplifier 36 is coupled to a current averaging circuit 40 which produces output signals which are representative of the average amplitude of current signal output of the amplifier 36. Output from the current averaging circuit 40 is coupled to a threshold and compare circuit 42 which compares the average current signal to a reference. If the average current sensed exceeds a predetermined level then an ON signal is produced at its output for coupling to a relay delay and driver circuit 44. The circuit 44 can be regarded as a lowpass filter in order to filter out transients which might appear in the signal and result in unwanted generation or suppression of driving current for the relay coil 30. The coil 30 is activated so as to close the contact 28 when the ON signal is produced by the threshold and compare circuit 42. The circuitry 32 includes an adjusting circuit 46 which enables a user to conveniently adjust the threshold current level required for switching of the contacts 28. The threshold circuit 42 is coupled to the LED indicator 14 which is preferably green.

The circuitry 32 also includes a power supply circuit 48 for supplying DC voltage levels for other parts of the circuitry, in the usual way.

FIG. 6 shows one circuit realisation for the circuitry 32 shown in FIG. 5. The power supply circuit 48 includes a voltage bridge 50 which produces supply voltages V_{DD} and V_{GG} as shown. The active conductor branch 21 to the first socket 8 makes a single loop through the coil 34. This is not shown in FIG. 6 for clarity of illustration. The coil 34 thus senses the current in the conductor branch 21 to the first socket 8. The current gain amplifier 36 includes a differential amplifier 52 which is connected for a preset gain but is subject to manual adjustment by means of a variable resistor 54. The variable resistor 54 is coupled to the thumb wheel 18 to enable manual adjustment of the gain of the amplifier 36. The current averaging circuit 40 includes an operational amplifier 56 coupled to the output from the amplifier 52. The amplifier 56 has coupled thereto rectifying diodes 58 and 60 to effectively rectify the output of the differential amplifier 52. The diodes 58 and 60 are coupled to a relatively large capacitor 62, the accumulated charge on which represents the average current levels sent by the current sensing coil 34. Output from the capacitor 62 is coupled to a DC amplifier 64, the output of which thus represents the amplified average value for the current supplied to the first socket 8. Output from the DC amplifier 64 is coupled to one input 66 of a differential amplifier 68. The other input 70 of the differential amplifier 68 is connected to a voltage reference level derived from a voltage bridge 72 coupled between the supply voltages V_{GG} and V_{DD}, as shown.

The arrangement is such that when the voltage on the input 66 reaches or exceeds the reference on input 70, the state of the amplifier 68 changes and this constitutes an ON signal which is coupled to an amplifier 74 in the delay and driver circuit 44. Output from the amplifier 74 is connected to a power transistor 76 the output in turn of which is coupled to the relay coil 30 by output line 78. The output line 78 includes a resistor 80 across which the LED indicator 16 is connected. The LED indicator 16 will be activated when the relay is activated thus providing a visual indication that the power has been supplied to the second socket 10. In the preferred arrangement, the LED 16 is red. The input to the amplifier 74 includes a resistance 82 and capacitance 84 which function as a delay or low pass filtering function in order to effectively eliminate short term or transient signals which may be present in the output of the amplifier 68.

The adjusting circuit 46 includes a differential amplifier 86 having one input 88 connected to a reference voltage derived from the voltage bridge 72 and another input coupled to the output of the DC amplifier 64. Output from the differential amplifier 86 is connected to the LED indicator 14. In use, the user of the connector 2 can adjust the circuitry so as to adjust the operation of the relay contacts 28 in accordance with a predetermined threshold average current in the branch conductor 21 to the first socket 8. More particularly, the user may connect a load such as a computer CPU to the first socket 8 and set the load or CPU in a standby state. The user can then manually adjust the thumb switch 18 so as to vary the gain of the current amplifier 36. From an initial position in which there is maximum gain, adjustment continues until output of the differential amplifier 86 goes negative at which point the relay coil 30 opens the contacts 28. Thus, the user can thereby effectively adjust the circuitry so that when the electrical load connected to the first socket 8 is in a standby state, no power is supplied to the second socket 10. When, however, the circuitry senses a non-transient increase in the average current supplied to the first socket 8 (corresponding to power up from standby), the contacts 28 will be closed and power will be supplied to the second socket 10, as required.

Conversely, if the non-transient average current supplied to the first socket 8 falls below the threshold value, the contact 28 will be opened and no power will be available at the second socket 10 (corresponding to a change from power on to standby of the load connected to the first socket 8).

FIG. 6 also shows a linked or fusible linked MOV (metal oxide varistor) 25 connected across active conductor 20 and neutral conductor 22. This is provided for purposes of surge and transient protection and may, for example, be replaced by a fusible link if desired.

As mentioned, the optional network and modem protection module 9 may be positioned on the casing 6, in place of the panel 7. This includes a printed circuit board which carries the components shown in FIG. 7. These include RJ45 connectors 92, 94 the pins of which are interconnected by conductive tracks 96. Two separate diodes 98, 100 are connected to each track 96. Each diode 98 has its anode connected to the respective track, and each diode 100 has its cathode connected to the respective track. The cathodes of all of the diodes 98 are connected to a common conductor 102, and the anodes of all of the diodes 100 are connected to a common conductor 104. Conductor 102 is coupled to a common ground 106 via a diode 108 and to the cathode of an over voltage protector 110. The conductor 104 is coupled to common ground 106 via a diode 112 and to the anode of the over voltage protector 1 10. The diode 108 is connected with its cathode connected to cathodes of diodes 98, and diode 112 is connected with its anode connected to the anodes of the diodes 100.

The circuit board of module 9 also carries two RJ11 connectors contacts of which are interconnected by conductive tracks 118. Two of the tracks 118 are connected by respective conductors 124, 126 to terminals of two two-terminal gas discharge protection devices 120, 122. The other terminals of the devices 120, 124 are connected together and thence to ground by conductor 128.

In use of the module 9, equipment such as a modem may be connected to an external telephone line via the RJ11 connectors 114, 116, and network equipment may be connected to network lines via the RJ45 connectors 92, 94.

In the normal condition of operation, the conductive tracks 96, and thus terminals of equipment or lines connected to these, are isolated from ground because the diodes 98 are reversely coupled with respect to diode 112, and diodes 100 are reversely coupled with respect to diode 112, protector 110 being in a non-conductive state. However, in the event of an over voltage condition on any one of the conductive tracks 96, (arising for example from a corresponding over voltage condition applied via connector 92 or connector 94), the tracks will be effectively connected to ground, by virtue of the over voltage protector assuming an electrically conductive state. In this condition, each track is connected to ground by the common polarity and series connected diodes 98 and 112, and by common polarity and series connected diodes 100 and 108.

So far as the RJ11 connectors are concerned, high voltage conditions prevailing on terminals of these to which the inner ones of conductive tracks 118 are connected will result in the gas discharge protection devices 120, 122 assuming conductive conditions and placing these at ground potential.

The described connector is particularly convenient in use. The casing 6, for example, may be readily mounted on a desktop or on a wall. The formation of the casing as a moulding in two parts provides easy interchangeability to accommodate power outlets suitable for use in various countries. For example, the peripheral form of the various sockets to suit different countries may be made the same, so that it is merely necessary, as described, to separate the two casing parts, to remove and replace sockets of one kind with sockets of another kind. The described peripheral rim on the sockets simply and reliably secures the sockets in position so that they do not rotate and are located in the axial direction.

The described control circuits may be readily modified to cater for 240 volt and 110 volt mains supplies. In particular, the design is such that minimal resistor and capacitor changes are needed for this purpose.

The circuit breaker 23 which is arranged to trip on overload affords current overload protection and the surge arresting MOV 25 provides additional protection against unwanted mains transients. The MOV 25 maybe connected to the mains supply by a link 27 (FIG. 6) that can be replaced by a fusible link where this is required. The described arrangement whereby adjustment of the tripping current required to turn the switching circuitry on or off can be adjusted by use of the thumb switch 18 is particularly convenient. The use of the optional panel 7 with its circuit board and protective components enables ready use of the connector with modems and the like, in a fashion which protects these against transients.

In the described arrangements the housing 6 is preferably arranged such that all of the electronics components are housed in the top part 6A of the casing 6 (i.e. secured only to this half) to facilitate a wall mounted configuration where part 6B is wall mounted and then part 6A is attached. The electronics components may be arranged on a circuit board 87 attached by screws 89 to upstanding posts 99 on part 6A, as shown in FIG. 11.

It is possible to incorporate into the connector a light sensing device such that power is turned off automatically when the connector is in a dark situation.

The optional modem and network protection module 7 facilitates connection of telephone line and network cards within network cabling and surge arresting and surge protection against transients of telephone and telephone networks.

Embodiments of the invention may:

a) Extend the life of the connected devices

b) Reduce the consumption of power

c) Reduce the amount of electricity or power bills

d) Reduce the risk of fire and electric shock

e) Reduce greenhouse gas emissions.

Many modifications will be apparent to those skilled in the art without departing from the spirit and scope of the invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

1. An electrical power connector, said connector including a power inlet, a first power outlet coupled to said power inlet, at least one second power outlet which is coupled to said power inlet by switch means, and switch control means for controlling the state of the switch means in accordance with the average current supplied to the first power outlet.

2. An electrical power connector, wherein the switch control means includes current sensing means for sensing AC current supplied to the first power outlet.

3. An electrical power connector as claimed in claim 1 or claim 2, including a circuit breaker which interrupts supply of electric power to the outlets when excess current is drawn.

4. An electrical power connector as claimed in any preceding claim, wherein means is provided for protecting equipment connected to the connector against high voltage spikes or other transients in the electric supply when applied to the connector.

5. An electrical power connector as claimed in any preceding claim, wherein the switch control means includes a current averaging circuit which produces output signals representative of the average AC current supplied to the first power outlet.

6. An electrical power connector as claimed in claim 5, wherein the switch control means includes a threshold circuit which compares the output signals of the current averaging circuit to a reference so as to produce a switching signal when a predetermined difference is detected at the input of the threshold circuit.

7. An electrical power connector as claimed in any preceding claim, wherein the switch means includes a relay coil and contacts and wherein the switch control means includes a relay driver circuit which is coupled between the output of the threshold circuit and the relay coil.

8. An electrical power connector as claimed in claim 2, or any one of claims 3 to 7 as directly or indirectly appended thereto, wherein the current sensing means includes an adjustable gain control means which can be adjusted so that the switch means changes state at a point corresponding to a predetermined electrical load connected to the first power outlet.

9. An electrical power connector as claimed in any preceding claim, including a delay or low pass filter coupled to in use at least partially inhibit turning on or off of the switch means caused by transient conditions in the current at the first power outlet.

10. A method of controlling the supply of power to a plurality of electrical loads, the method including the steps of monitoring the average current supplied to a first of said loads, controlling switch means coupled to the loads other than said first load in accordance with said monitored average current to thereby control supply of power to the loads other than said first load.

11. A method of controlling the supply of power to a plurality of electrical loads, wherein the first load has an off or standby state and wherein the step of controlling the switch means is adjusted so that the switch means is off when the first load is in the off or standby state.

12. A method as claimed in claim 11, wherein said off state is a state where no current is drawn by the first load.

13. A method as claimed in any one of claims 10 to 12, wherein, in the standby state, current drawn by the first load is substantially less than the current drawn when the first load is in an operative state.

14. A method as claimed in any one of claims 10 to 13, including the step of monitoring the average current supplied to the first of said loads in a standby state and adjusting control means for controlling said switch means so that when there is an increase in average current from said standby state, said switch means changes state to thereby supply power to loads other than said first load.

15. An electrical power connector having an electrical power outlet, and electrical circuitry connected to the outlet, the outlet being removably retained between two parts of a casing of the connector which are releasably connected together, whereby, on release of the connection between the parts, the outlet is released to permit replacement thereof.

16. An electrical power connector as claimed in claim 15, wherein the parts of the casing, and the outlet, are formed so as that, when the outlet is retained between the parts of the casing, movement of the outlet inwardly and outwardly and rotationally with respect to the casing is prevented by engagement of peripheral protrusions or other portions of the outlet with portions of the casing.

17. An electrical power connector as claimed in claim 15 or claim 16, wherein one of said casing parts carries the electrical circuitry, and the other is arranged for mounting of the connector on a surface.

18. An electrical power connector as claimed in any one of claims 14 to 17, wherein the outlet is one of two power outlets each removably retained between the casing parts.

19. An electrical power connector as claimed in claim 18, wherein the outlets are at opposite ends of the casing.

20. An electrical power connector having an electrical power inlet and an electrical power outlet, and electrical circuitry interconnecting these, the connector having a casing being formed from two parts releasably connected together, one said part carrying the electrical circuitry, and the other being arranged for mounting of the connector on a surface.

21. A connector substantially as hereinbefore described, with reference to the accompanying drawings.

22. A method of controlling the supply of power to a plurality of electrical loads, substantially as hereinbefore described, with reference to the accompanying drawings.
